(19) United States
(12) Patent Application Publication
(10) Pub. No.: US 2012/0327631 A1
(43) Pub. Date: Dec. 27, 2012

(54) LED LIGHTING DEVICE

(75) Inventor: JIAN-SHIHN TSANG, Tu-Cheng (TW)

(73) Assignee: HON HAI PRECISION INDUSTRY CO., LTD., Tu-Cheng (TW)

(21) Appl. No.: 13/304,297

(22) Filed: Nov. 23, 2011

(30) Foreign Application Priority Data
Jun. 27, 2011 (TW) 100122357

(51) Int. Cl. F21V 9/16

(52) U.S. Cl. 362/84

(57) ABSTRACT

An LED lighting device comprises an LED light source and a luminescent conversion portion. Rotation of the luminescent conversion portion relative to the LED light source or rotation of the LED light source relative to the luminescent conversion portion is used to produce a variety of color temperatures. The luminescent conversion portion has phosphors unevenly distributed therein.

### TECHNICAL FIELD

The disclosure relates generally to lighting devices, and more particularly to a light emitting diode (LED) lighting device.

### DESCRIPTION OF THE RELATED ART

LEDs have become more popular due to their low power consumption, high efficiency, quick reaction time, long life and the fact that they contain no mercury; hence, LED lighting devices are gradually replacing fluorescent lamps and incandescent lamps. An LED lighting device may include an LED disposed on a printed circuit board (PCB) and an encapsulation layer with one luminescent conversion element covering on the LED, such that light emitted from the LED may excite the luminescent conversion element to produce light of a different wavelength. However, as the disclosure of China Patent Application Publication No. CN 101826518 A, the luminescent conversion element will be fixed in place and not adjustable nor easily replaced.

### BRIEF DESCRIPTION OF THE DRAWINGS

FIG. 1 is a schematic diagram showing an LED lighting device in accordance with a first embodiment of the disclosure.

FIG. 2A is a cross section of a luminescent conversion portion in accordance with one embodiment of FIG. 1.

FIG. 2B is a top view of a luminescent conversion portion in accordance with another embodiment of FIG. 1.

FIG. 3 is a schematic diagram showing an LED lighting device in accordance with a second embodiment of the disclosure.

FIG. 4 is a schematic diagram showing an LED lighting device in accordance with a third embodiment of the disclosure.

### DETAILED DESCRIPTION

Exemplary embodiments of the disclosure will now be described with reference to the accompanying drawings.

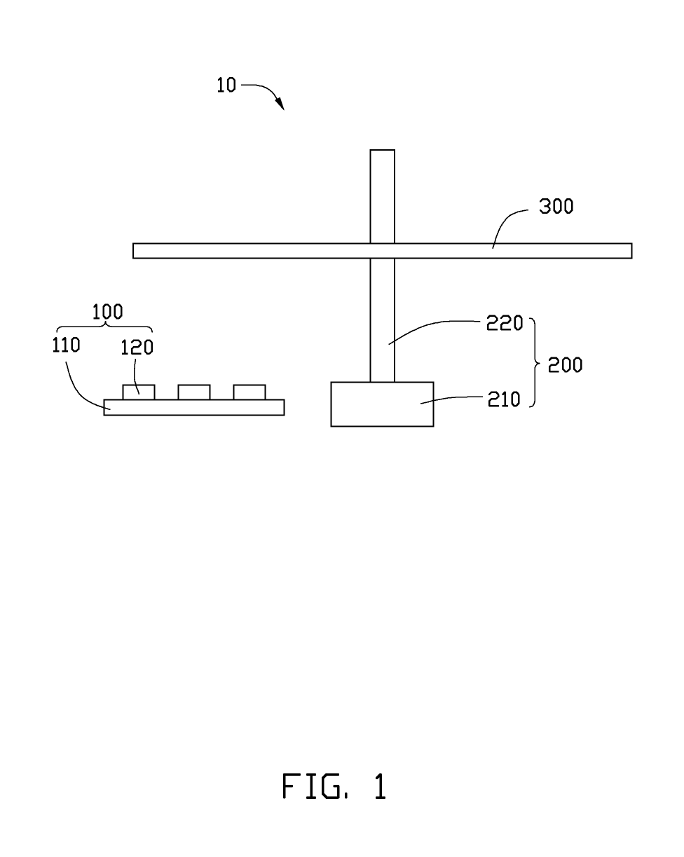

Referring to FIG. 1, the disclosure provides a first embodiment of an LED lighting device 10, comprising an LED light source 100, a driving device 200 and a luminescent conversion portion 300.

The LED light source 100 is located on one end of the driving device 200. The LED light source 100 comprises a substrate 110 and a plurality of LEDs 120 disposed on the substrate 110. The LEDs 120 are able to emit ultraviolet, blue light, green light, red light or white light.

The driving device 200 comprises a driver 210 and a shaft 220, wherein the driver 210 is joined to one end of the shaft 220. In this embodiment, the driver 210 is used to cause the shaft 220 to rotate around an axis thereof.

The luminescent conversion portion 300 is located on a light emitting path of the LED light source 100 and connects to the shaft 220 of the driving device 200. In this embodiment, the luminescent conversion portion 300 is a thin circular disk 300, wherein the shaft 220 is joined to a central portion of the disk 300 such that the luminescent conversion portion 300 is rotatable via the shaft 220.

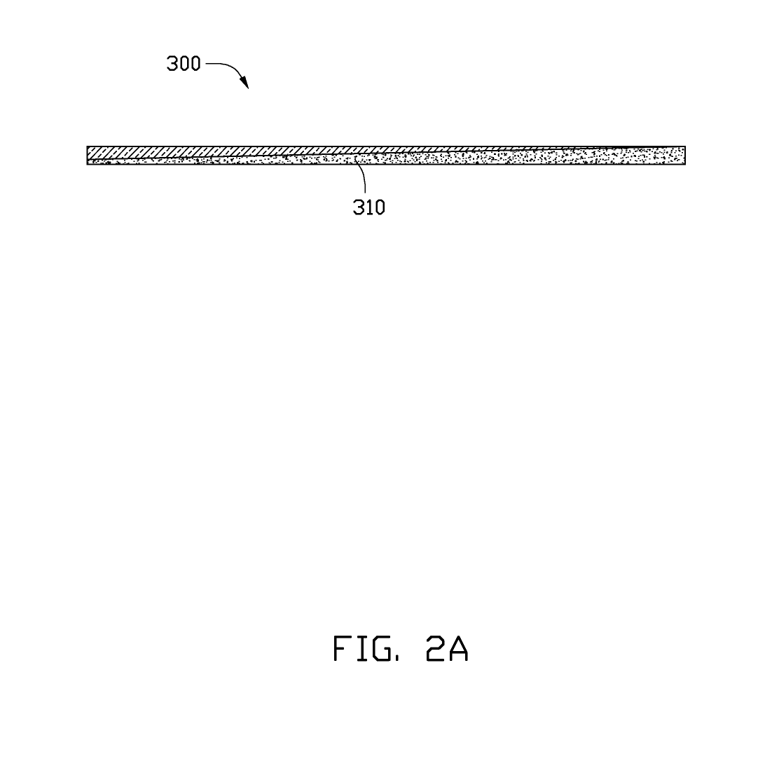

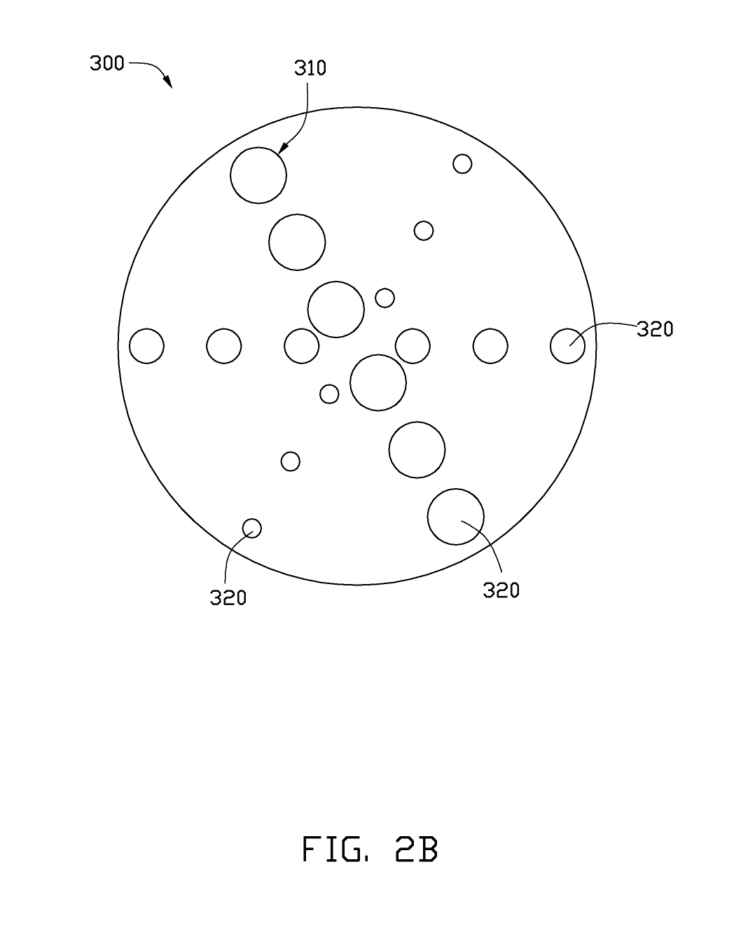

As shown in FIG. 2A, the disk 300 comprises a gradient of phosphors, wherein a phosphor layer 310 with a thickness decreasing gradually from one rim (i.e., right end of FIG. 2A) of the luminescent conversion portion 300 to the opposite one (i.e., left end of FIG. 2A). The luminescent conversion portion 300 can be rotated, to position different phosphor densities in the path of light from the LED light source 100 to produce different color temperatures. In other embodiments as shown in FIG. 2B, the phosphor layer 310 comprises a pattern of sections 320 that may have different phosphor densities and different dimensions and rotated into position in the path of light according to desired color temperatures.

The phosphor layer 310 can be composed of sulfide, silicate, nitride, nitride oxide, YAG phosphor or hybrid thereof. In one embodiment, the luminescent conversion portion 300 further comprises light diffuse particles (not shown) for enhancing the light emitting efficiency of the LED lighting device 10 and uniformity of the light. Further, the luminescent conversion portion 300 also can be a triangular portion, a rectangular portion or any polygonal portion. Furthermore, the luminescent conversion portion 300 can further comprise a plurality of micro-lenses located on a light emitting surface of the luminescent conversion portion 300. These micro-lenses can be concave or convex lenses.

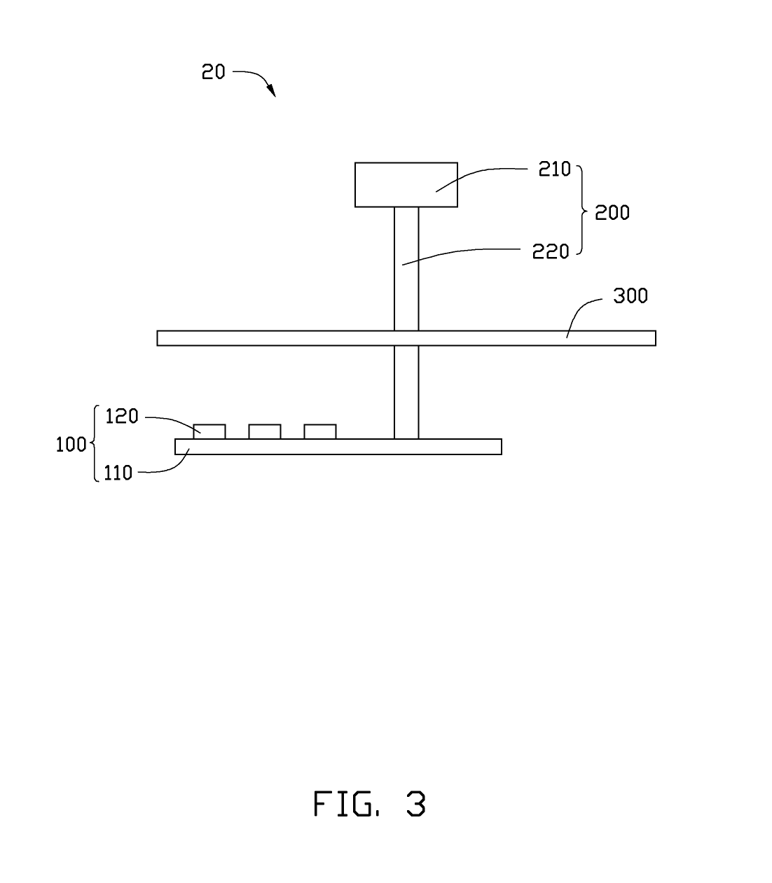

Referring to FIG. 3, the disclosure provides a second embodiment of an LED lighting device 20, which is similar to the first embodiment but with the one end of the shaft 220 joined to the driver 210 and the other end of the shaft 220 joined to the substrate 110 of the LED light source 100 through the luminescent conversion portion 300. The plurality of the LEDs 120 disposed on the substrate 110 is directed to the luminescent conversion portion 300. During operation, the substrate 110 is spun to position different densities of phosphor in the path of light from the LED light source 100 to produce different color temperatures.

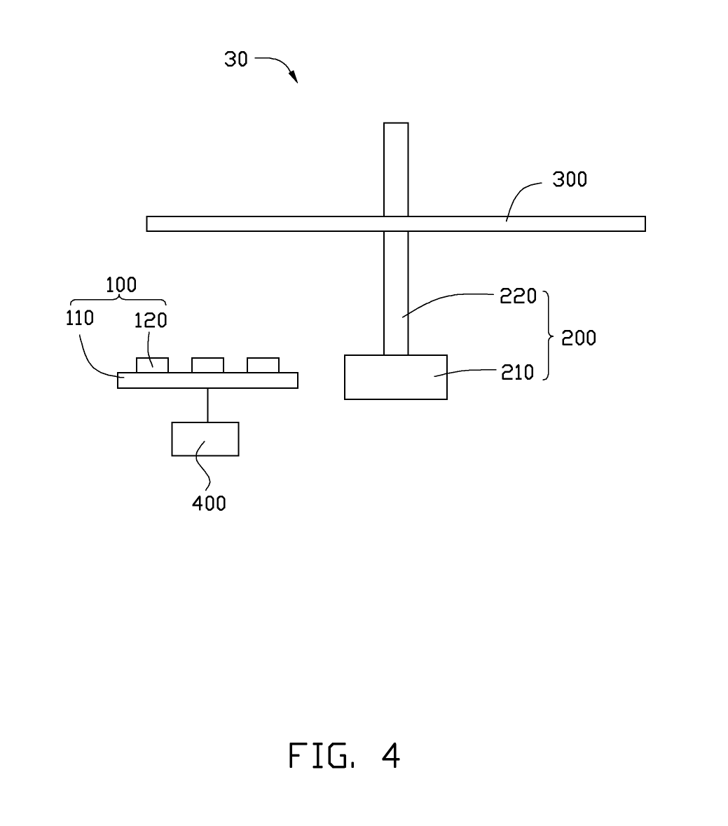

Referring to FIG. 4, the disclosure provides a third embodiment of an LED lighting device 30, which is similar to the first embodiment only except that the LED light source 30 further comprises a pulse-width modulation (PWM) 400. The PWM 400 is able to adjust pulse width of each LED to control illuminating time of the LED light source 100 as the luminescent conversion portion 300 rotates, so that different phosphor density areas of the phosphor layer 310 may be illuminated for different amounts of time to produce a variety of color temperatures.

Accordingly, the present disclosure provides the LED lighting device using rotation of the luminescent conversion portion relative to the LED light source or rotation of the LED light source relative to the luminescent conversion portion to produce a variety of color temperatures. Moreover, the PWM also can be used to adjust illuminating time of the LED light source as the substrate or the luminescent conversion portion rotates.

It is to be understood, however, that even though numerous characteristics and advantages of the disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An LED lighting device, comprising:
an LED light source, comprising a substrate and a plurality of LEDs disposed on the substrate; and
a luminescent conversion portion, located on a light emitting path of the LED light source, having phosphors unevenly distributed therein; and
a driving device, comprising a shaft and a driver drivably connecting with the shaft whereby the driving device can drive the shaft to rotate, wherein the shaft is joined to the luminescent conversion portion such that the luminescent conversion portion is rotatable related to the substrate via the shaft by a driving of the driver.

2. The LED lighting device as claimed in claim 1, wherein the LED light source comprises a pulse-width modulation (PWM) for controlling illuminating time of the LED light source.

3. The LED lighting device as claimed in claim 1, wherein the phosphors have a thickness decreasing gradually from one rim of the luminescent conversion portion to the opposite one.

4. The LED lighting device as claimed in claim 1, wherein the phosphors are distributed in a pattern in the luminescent conversion portion, the pattern comprising a plurality of sections having different dimensions.

5. The LED lighting device as claimed in claim 1, wherein the luminescent conversion portion comprises light diffusing particles.

6. The LED lighting device as claimed in claim 1, wherein the luminescent conversion portion comprises a plurality of micro-lenses located on a light emitting surface of the luminescent conversion portion.

7. An LED lighting device, comprising:
an LED light source, comprising a substrate and a plurality of LEDs disposed on the substrate;
a luminescent conversion portion, located on a light emitting path of the LED light source, having a gradient of phosphors;
a driving device, comprising a shaft and a driver joined to one end of the shaft, wherein the shaft is joined to the substrate such that the LED light source is rotatable related to the luminescent conversion portion via the shaft from the driver.

8. The LED lighting device as claimed in claim 7, wherein the LED light source comprises a PWM for controlling illuminating time of the LED light source.

9. The LED lighting device as claimed in claim 7, wherein the phosphors of the luminescent conversion portion constitute a phosphor layer with a thickness decreasing gradually from one rim of the luminescent conversion portion to the other oppositely.

10. The LED lighting device as claimed in claim 9, wherein the thickness of the phosphor layer is distributed in a pattern in accordance with a rotating direction of the substrate.

11. The LED lighting device as claimed in claim 7, wherein the luminescent conversion portion comprises light diffusing particles.

12. The LED lighting device as claimed in claim 7, wherein the luminescent conversion portion comprises a plurality of micro-lenses located on a light emitting surface of the luminescent conversion portion.

13. An LED lighting device, comprising:
an LED light source, comprising a substrate and a plurality of LEDs disposed on the substrate;
a luminescent conversion portion, located on a light emitting path of the LED light source, having a the phosphor layer with a numbers of sections distributed in a pattern;
a driving device, comprising a shaft and a driver joined to one end of the shaft; and
a PWM, connected to the LED light source, for controlling illuminating time of the LED light source.

14. The LED lighting device as claimed in claim 13, wherein the shaft is joined to the luminescent conversion portion such that the luminescent conversion portion is rotatable related to the substrate via the shaft from the driver.

15. The LED lighting device as claimed in claim 14, wherein these sections are distributed in a pattern with different dimensions.

16. The LED lighting device as claimed in claim 13, wherein the shaft is joined to the substrate such that the LED light source is rotatable related to the luminescent conversion portion via the shaft from the driver.

17. The LED lighting device as claimed in claim 16, wherein these sections are distributed in a pattern with different dimensions.

18. The LED lighting device as claimed in claim 13, wherein the luminescent conversion portion comprises light diffusing particles.

19. The LED lighting device as claimed in claim 13, wherein the luminescent conversion portion comprises a plurality of micro-lenses located on a light emitting surface of the luminescent conversion portion.
